(19) United States
(12) Patent Application Publication
(10) Pub. No.: US 2012/0253951 A1
(43) Pub. Date: Oct. 4, 2012

(54) SCALABLE INVENTORY PROTECTION AND OPTIMIZATION IN DISPLAY ADVERTISING

(75) Inventors: Abhay Gupta, Lost Altos, CA (US); Ramana Yemeni, Cupertino, CA (US); Senthil Subramanian, Sunnyvale, CA (US); Tsung-Jen Chou, Menlo Park, CA (US)

(73) Assignee: Yahoo! Inc., Sunnyvale, CA (US)

(21) Appl. No.: 13/074,096

(22) Filed: Mar. 29, 2011

(51) Int. Cl. G06F 17/30; G06Q 30/00

(52) U.S. Cl. 705/14.73; 707/713; 707/E17.131

(57) ABSTRACT

Systems and methods for determining the availability of resources, such as Internet advertising opportunities, are described herein. A query may be received to determine eligible resource inventory for a set of attributes and attribute values received in the query. The query may overlap with inventory that protected, and thus is desired to not be covered by the query. Accordingly, the query may be modified to include additional attributes and attribute values, or to include one or more inventory protection tags, to prevent the query from overlapping with the protected inventory. Furthermore, advertisement campaigns may be modified in a similar manner to prevent protected inventory from matching the advertisement campaigns. Still further, individual inventory items may be annotated with tags to prevent the inventory items from being associated with protected inventory defined by tags.

### BACKGROUND OF THE INVENTION

1. Field of the Invention

The present invention generally relates to systems and methods for processing queries to determine the availability of online advertisements.

2. Background

The Internet has emerged as a powerful advertising tool. It is commonplace to see advertisements on many Web sites. For example, advertisements may be displayed on search Web sites and may be targeted to individuals based upon search terms submitted by the individuals. Other Web sites, such as news and sports Web sites, may provide space for display advertisements. Proprietors of these Web sites may sell advertising space to advertisers to offset the costs associated with operating the Web sites as well as to turn a profit.

To place an advertisement, an advertiser may enter into a contract with a publisher that operates an ad serving system to serve a number of advertisement impressions. An impression corresponds to the display of an advertisement to a user. For example, the advertiser may purchase 10,000 impressions for $100 and may specify a particular target audience, such as users that like sports.

When preparing to enter a contract, the advertiser (or an agent thereof) may interact with a system that allows the advertiser to specify the types of advertisement opportunities in which the advertiser is interested so as to determine the availability thereof. This may involve selecting one or more target attributes from among a set of attributes and then specifying a target value for each of the target attributes. The target attributes may include, for example, attributes associated with the viewers that will view an impression (e.g., gender, age group), attributes associated with the content of the Web page on which the impression will be delivered, attributes involving the location of the impression on the Web page, a time period during which the impression will be served, and the like. The target values specified by the advertiser for the target attributes can then be used as a query to search for available advertising opportunities having attributes/value combinations that match the target attributes/values.

Advertisers frequently advertise products and/or services online in the form of an “advertising campaign.” An advertising campaign typically includes a set of advertisements provided by an advertiser that share a theme to make up an integrated marketing communication. Advertisement serving systems enable advertisers to set up advertising campaigns to target particular advertisement impressions. Publishers (e.g., web site providers, etc.) of the advertisement impressions may desire to package together sets of advertisement impressions, and may set up rules to manage the allocation of the packaged sets of advertisements to various competing advertising campaigns. However, there may be a large number of advertising campaigns and a large number of advertisement impressions that are managed by an advertisement serving system, and the packaged sets of advertisements can overlap in complex ways. Each of these issues can make it difficult for an advertisement serving system to provide inventory protection/optimization in an efficient and scalable manner.

### BRIEF SUMMARY OF THE INVENTION

Systems and methods for determining the availability of resources, such as Internet advertising opportunities, are described herein. A query may be received to determine eligible resource inventory for a set of attributes and attribute values received in the query. The query may overlap with inventory that protected, and thus is desired to not be covered by the query. Accordingly, the query may be modified to include additional attributes and attribute values, or to include one or more inventory protection tags, to prevent the query from overlapping with the protected inventory. Furthermore, advertisement campaigns may be modified in a similar manner to prevent protected inventory from matching the advertisement campaigns. Still further, individual inventory items may be annotated with tags to prevent the inventory items from being associated with protected inventory defined by tags.

In one implementation, a method and system for determining the availability of resources are provided. A query is received that specifies one or more constraints on one or more attributes associated with the resources. The received query is converted into a modified query that includes the specified one or more constraints and an inventory protection constraint. The inventory protection constraint is configured to prevent one or more designated available resources (protected inventory) from matching the modified query. A number of available resources for the modified query is determined by processing a first number of resources obtained for the modified query.

When booked, one or more campaigns may be modified in a similar manner to include the inventory protection constraint and/or further inventory protection constraints.

In another implementation, a method and system for determining the availability of resources is provided. A query is received that specifies one or more constraints on one or more attributes associated with the resources. The received query is converted into a modified query that includes the specified one or more constraints and an inventory protection tag configured to prevent one or more designated available resources from matching the modified query. A number of available resources for the modified query is estimated by processing a first number of resources obtained for the modified query.

Furthermore, one or more campaigns and received impression requests may be modified in a similar manner as the received query to include the inventory protection tag and/or further inventory protection tags.

Computer program products are also described herein. The computer program products include a computer-readable medium having computer program logic or code recorded thereon for modifying queries to determine the availability of resources, for modifying campaigns, for modifying received impression requests, and for enabling further embodiments, according to the implementations described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example display advertising system in which an embodiment may operate.

FIG. 2 illustrates supply samples that may be returned by a supply forecasting system in response to the submission of a query in accordance with an embodiment.

FIG. 3 illustrates a plurality of advertising campaigns that may exist at the time a query is being processed and advertising opportunity demand associated therewith in accordance with an embodiment.

FIG. 4 illustrates the allocation of a forecasted supply of advertising opportunities represented by supply samples to existing advertising campaigns in accordance with an embodiment.

FIG. 5 illustrates supply samples that may be returned by a supply forecasting system in response to the submission of a query in accordance with an embodiment.

FIG. 6 illustrates a subset of the supply samples of FIG. 7 that match a received query, including a supply sample that includes protected inventory that is designated as ineligible supply, in accordance with an embodiment.

FIG. 7 shows a block diagram of an admission control system configured to modify queries, according to an example embodiment.

FIG. 8 shows a flowchart providing a process for processing a query for available resources by modifying the query, according to an example embodiment.

FIG. 9 shows a process for estimating a number of available resources for a modified query, according to an example embodiment.

FIG. 10 shows a process for storing a booked advertising campaign based on a modified query, according to an example embodiment.

FIG. 11 shows a flowchart providing a process for storing a booked advertising campaign based on the originally received query, according to an example embodiment.

FIG. 12 shows a process for converting advertisement campaigns into modified advertisement campaigns, according to an example embodiment.

FIG. 13 shows a block diagram of an admission control system configured to modify advertisement campaigns, according to an example embodiment.

FIG. 14 shows a flowchart providing a process for processing a query for available resources by modifying the query with tags to avoid protected inventory, according to an example embodiment.

FIG. 15 illustrates a tagged advertising campaign, according to an example embodiment.

FIG. 16 shows a flowchart for processing a resource inventory that includes a plurality of resources, according to an example embodiment.

FIG. 17 illustrates a tagged inventory item, according to an example embodiment.

FIG. 18 shows a flowchart providing a process for processing a received impression request, according to an example embodiment.

FIG. 19 is a block diagram of a computer system that may be used to implement one or more aspects of the present invention.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are described in the following sections. It noted that the section/subsection headings provided herein are not intended to be limiting. Embodiments are described throughout this document, and any type of embodiment may be included under any section/subsection.

### B. Example Display Advertising System

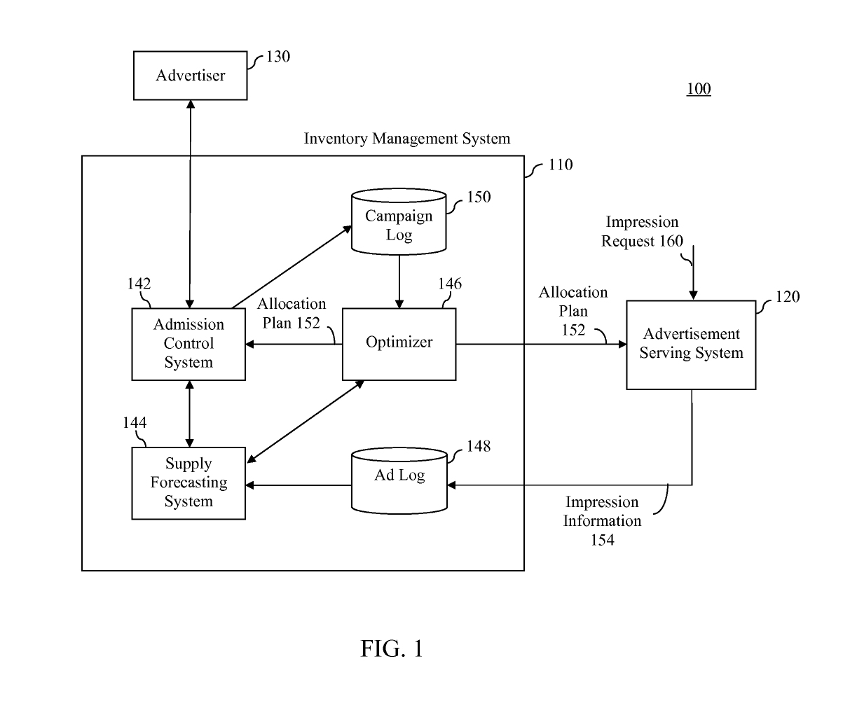

FIG. 1 is a block diagram of an example display advertising system 100 in which an embodiment of the present invention may operate. As shown in FIG. 1, display advertisement system 100 includes an inventory management system 110 and an advertisement serving system 120. Inventory management system 110 is an automated system that is designed to enable advertisers to purchase or reserve in advance advertising opportunities that will arise when users of the Internet visit Web pages. Such purchasing or reserving in advance is also referred to herein as “booking.” Advertisement serving system 120 is an automated system that is designed to serve display advertisements on behalf of such advertisers when such booked advertising opportunities arise.

In accordance with the system shown in FIG. 1, an advertiser, such as advertiser 130, interacts with inventory management system 110 to set up an advertising campaign, wherein part of setting up an advertising campaign includes booking certain advertising opportunities. Based on such booking activity, inventory management system 110 updates an allocation plan 152 that indicates which advertising opportunities have been booked by which campaigns and intermittently provides allocation plan 152 to advertisement serving system 120.

Advertisement serving system 120 utilizes the most recently-received version of allocation plan 152 to determine which display advertisements to serve when a Web page is delivered to a user that includes a particular advertising opportunity. In other words, advertisement serving system 120 determines which campaigns consume which advertising opportunities based on information provided in allocation plan 152. When a display advertisement is served, an impression is said to have occurred, and information about the impression is stored in an advertisement (“ad”) log 148 that comprises part of inventory management system 110. Such impression information 154 includes an identification of the advertising campaign to which the impression was allocated. Information stored in ad log 148 is then used by inventory management system 110 to update allocation plan 152 to account for the consumption of certain advertising opportunities by certain advertising campaigns.

Although reference is made herein to interactions between advertisers, such as advertiser 130, and inventory management system 110, it is to be understood that other entities, including but not limited to agents acting on behalf of advertisers, may also interact with inventory management system 110 to set up advertising campaigns, query and book advertising opportunities, and the like.

To enable advertisers to book certain targeted advertising opportunities for their advertising campaigns and to forecast and track the consumption of such booked advertising opportunities by various advertising campaigns, display advertising system 100 characterizes each impression that is served using a predefined set of attributes and associated values. For example, the predefined set of attributes may include but are not limited to: a content topic (e.g., sports, news, finance) of a Web page on which the impression is served, a position of the impression on such Web page, a gender of a viewer of the impression, an age category of a viewer of the impression, a geographical location of a viewer of the impression, and a behavior tag that signifies certain behaviors or preferences of a viewer of the impression.

Thus, for example, an impression denoted IMP1 may be represented by the following set of <attribute, value> pairs:
IMP1: Content Topic=Sports, Position=NREC, Gender=Male, Age Category=2, Location=CA, Behavior Tag=Politics, . . .
   In accordance with this representation, advertisement impression IMP1 is served on a Web page having a content topic of sports, is served in a northern rectangle (NREC) position on the Web page, is served to a male user in an age category represented by the number 2, wherein the male user is geographically located in California (CA) and has shown a prior interest in content related to politics.

Inventory management system 110 is further described as follows. As shown in FIG. 1, in addition to ad log 148 which was discussed above, inventory management system 110 further includes an admission control system 142, a supply forecasting system 144, an optimizer 146, and a campaign log 150. Each of these components is described as follows.

Admission control system 142 is configured to receive booking queries from advertisers, such as advertiser 130, that specify advertising opportunities in which the advertiser is interested. The queries specify target values for some or all of the attributes associated with the advertising opportunities they target. Thus, for example, with continued reference to the particular example <attribute, value> schema discussed above, an example query Q1 might be specified as follows:

Q1: Content Topic=Sports, Position=NREC, Location=CA

Here the target attributes are Content Topic, Position and Location, and each target attribute has a designated target value. In accordance with these target <attribute, value> pairs, query Q1 is seeking advertising opportunities in a northern rectangle position of Web pages having a content topic of sports and that will be served to a user located in California. Another example query Q2 might be specified as follows:

Q2: Content Topic=News, Position=EREC, Age Category=3

Here the target attributes are Content Topic, Position and Age Category, and each target attribute has a designated target value. In accordance with these target <attribute, value> pairs, query Q2 is seeking advertising opportunities in an eastern rectangle position of Web pages having a content topic of news and that will be served to a user within age category 3.

Admission control system 142 interacts with supply forecasting system 144 to obtain an estimate of how many advertising opportunities will be available in the future that match or otherwise qualify for a query. An impression matches or otherwise qualifies for a query when the values of its attributes satisfy the conditions specified by the query. Thus, for example, an advertising opportunity in the form of an unconsumed impression IMP1 may be specified as follows:
IMP1: Content Topic=Sports, Position=NREC, Gender=Male, Age Category=2, Location=CA, Behavior Tag=Politics, . . .
   It can be seen from this example that impression IMP1 matches query Q1 as described above, but does not match query Q2.

Booking queries are intended to determine the availability of as-yet-unconsumed impressions at some point in the future. Thus, in certain embodiments, the queries include a duration attribute, the value of which specifies a time period over which the desired advertising opportunity will arise. Thus for example, a query may specify a target profile in accordance with

Profile: Content Topic=Sports, Position=NREC, Location=CA

as well as a target duration in accordance with
Duration=Mar. 15, 2011-Mar. 31, 2011.
   In this example, the timeframe Mar. 15, 2011-Mar. 31, 2011 is assumed to be in the future. To process such a query, inventory management system 100 must be able to forecast the supply of advertising opportunities that will arise during the specified future time window. This function is performed by supply forecasting system 144.

In particular, supply forecasting system 144 utilizes historical information obtained from ad log 148 to model the future availability of various types of advertising opportunities. Optimizer 146 operates to obtain a forecasted supply of advertising opportunities from supply forecasting system 144 and allocates such forecasted supply among various existing advertising campaigns, information about which is stored in campaign log 150. In particular, optimizer 146 uses information about future supply obtained from supply forecasting system 144 and booked demand obtained from campaign log 150 to update allocation plan 152. As noted above, allocation plan 152 is delivered to advertisement serving system 120 and is used thereby to drive the allocation of certain types of impressions to certain advertising campaigns.

As shown in FIG. 1, allocation plan 152 is also intermittently delivered to admission control system 142. Admission control system 142 uses the most recently-received allocation plan 152 to make decisions about booking new advertising campaigns. For example, admission control system 142 may use allocation plan 152 along with forecasted supply information from supply forecasting system 144 to determine whether a certain number of advertising opportunities are available to be booked by a new advertising campaign. If admission control system 142 books a new advertising campaign, then admission control system 142 will send information concerning the booking to campaign log 150 so that such information may be subsequently considered by optimizer 146 when generating an updated version of allocation plan 152.

### C. Example Query Processing Technique

An example technique by which admission control system 142 of display advertising system 100 may process a booking query is described as follows. The query processing described in this section does not involve bulk queries. Rather, the handling of such bulk queries will be described in subsequent sections.

Generally speaking, when admission control system 142 receives a booking query, it first interacts with supply forecasting system 144 to obtain a relevant forecasted supply of advertising opportunities that match the query. Admission control system 142 then uses allocation plan 152 obtained from optimizer 146 to determine how much of this forecasted supply is already allocated to existing advertising campaigns and reduces the forecasted supply accordingly to identify an available supply. Admission control system 142 then returns the available supply of advertising opportunities to the submitter of the query.

The forecasted supply of advertising opportunities that is provided by supply forecasting system 144 in response to the processing of a query is represented by a number of advertising opportunity samples, also referred to herein as supply samples. The technique by which supply forecasting system 144 obtains such supply samples is termed “representative sampling.” In one embodiment, each supply sample has a weight associated with it that reflects the amount of advertising opportunities represented by that sample. In further accordance with such an embodiment, the total forecasted supply for a query may be the sum of the weights of the supply samples.

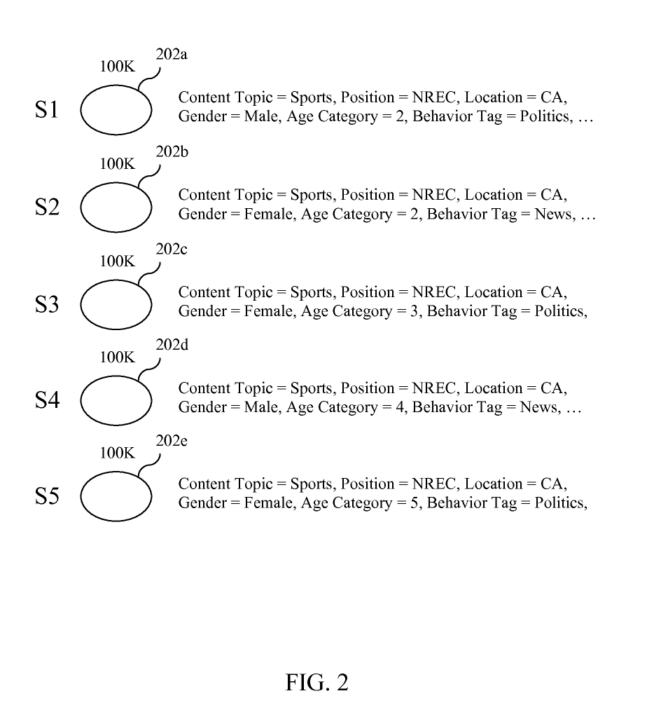

For example, FIG. 2 illustrates five supply samples, S1-S5 (corresponding to reference numerals 202a-202e), that may be returned by supply forecasting system 144 in response to the submission of a given query Q3, wherein
Q3: Content Topic=Sports, Position=NREC, Location=CA, Duration=Mar. 15, 2011-Mar. 31, 2011
   In accordance with this example, responsive to receiving query Q3, supply forecasting system 144 determines a total amount of forecasted supply, which is 500,000 advertising opportunities. Supply forecasting system 144 then selects a subset of the forecasted supply, which in this example is five supply samples, to represent the total forecasted supply. The number of advertising opportunities represented by each supply sample S1-S5 is denoted by a weight associated with each sample. In this case, each supply sample S1-S5 represents 100,000 samples and thus, supply samples S1-S5 collectively represent all 500,000 forecasted advertising opportunities. It is to be understood that supply samples S1-S5 shown in FIG. 2 have timestamps in the duration range of query Q3 as discussed above (i.e., in the time range of Mar. 15, 2011-Mar. 31, 2011).

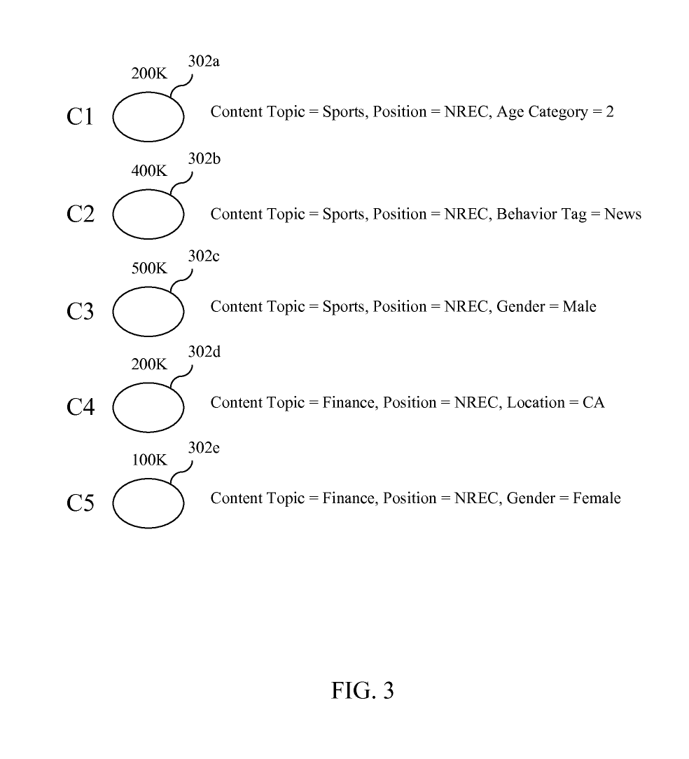

After obtaining the supply samples from supply forecasting system 144, admission control system 142 determines the existing demand for the advertising opportunities represented by such samples. Such existing demand is due to the allocation of the advertising opportunities to existing advertising campaigns and can be determined from allocation plan 152. For example, FIG. 3 illustrates five advertising campaigns, C1-C5 (corresponding to reference numerals 302a-302e), that may exist at the time the query Q3 is being processed and the demand associated with each. In accordance with the example of FIG. 3, campaign C1 will consume 200,000 advertising opportunities that have a profile of:

Content Topic=Sports, Position=NREC, Age Category=2.

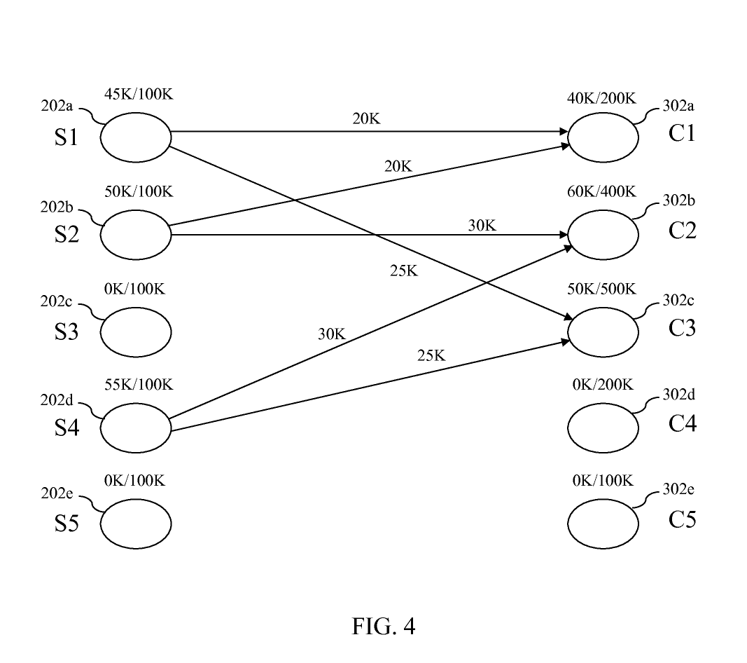

As further shown in FIG. 3, campaigns C2-C5 will consume varying amounts of other types of advertising opportunities. It is to be understood that for an advertising campaign to consume advertising opportunities, the advertising campaign must be active during the same time window in which the advertising opportunities arise. With reference to the example of FIG. 3, it may be assumed that each of advertising campaigns C2-C5 is active during the relevant time window of Mar. 15, 2011-Mar. 31, 2011. Using the supply samples provided by supply forecasting system 144 and the demand information obtained from allocation plan 152, admission control system 142 determines an allocation of the forecasted supply of advertising opportunities represented by the supply samples to each of the existing advertising campaigns. For example, FIG. 4 illustrates the allocation of the forecasted supply of advertising opportunities represented by supply samples S1-S5 as previously described in reference to FIG. 2 to existing advertising campaigns C2-C5 as previously described in reference to FIG. 3.

As shown in FIG. 4, advertising campaign C1 can consume advertising opportunities represented by supply samples S1 and S2 since the target attribute/values associated with advertising campaign C1 (i.e., Content Topic=Sports, Position=NREC, Age Category=2) match the attribute/values associated with supply samples S1 and S2. In further accordance with this example, based on information included in allocation plan 152, admission control system 142 estimates that advertising campaign C1 will consume 20,000 of the advertising opportunities represented by supply sample S1 and 20,000 of the advertising opportunities represented by supply sample S2.

As further shown in FIG. 4, admission control system 142 also determines that advertising campaign C2 will consume 30,000 of the advertising opportunities represented by supply sample S2 and 30,000 of the advertising opportunities represented by supply sample S4 and that advertising campaign C3 will consume 25,000 of the advertising opportunities represented by supply sample S1 and 25,000 of the advertising opportunities represented by supply sample S4. Admission control system 142 further determines that advertising campaigns C4 and C5 will not consume any of the advertising opportunities represented by supply samples S1-S5 because these advertising campaigns have target attribute/values associated therewith that do not match any of the attribute/values associated with any of supply samples S1-S5.

After admission control system 142 has determined the allocation of the forecasted supply of advertising opportunities represented by the supply samples to each of the existing advertising campaigns, admission control system 142 then reduces the weights associated with the supply samples accordingly. Thus, in further accordance with the example shown in FIG. 4, since a total of 45,000 of the advertising samples represented by supply sample S1 have been allocated to existing advertising campaigns, the weight associated with supply sample S1 is reduced to 55,000. Using a like approach, the weight associated with supply sample S2 is reduced to 50,000 and the weight associated with supply sample S4 is reduced to 45,000. The weights associated with supply samples S3 and S5 are not reduced, since none of the advertising opportunities represented by those supply samples have been allocated to existing advertising campaigns.

Admission control system 142 then sums the adjusted weights associated with the supply samples to determine an available supply of advertising opportunities that will satisfy the query. For example, in further accordance with the example of FIG. 4, the reduced weights of 55,000 for supply sample S1, 50,000 for supply sample S2, and 45,000 for supply sample S4 are added to the 100,000 weight for supply sample S3 and the 100,000 weight for supply sample S5 to obtain a total available supply of 350,000 advertising opportunities that will satisfy the query Q.

### D. Example Query Processing Techniques for Handling Protected Inventory

Advertising campaigns provide advertisements to be delivered over a period of time in the future. As such, an advertisement serving system, such as display advertising system 100 of FIG. 1, forecasts the advertisement impressions that match the advertising campaigns, and determines the eligible inventory and available inventory for the advertising campaigns based on the forecasted inventory. Advertisement serving systems may also offer ways to package the advertisement inventory into multiple subsets and make various subsets accessible to various advertising campaigns. For instance, premium packages of advertisement inventory may be set aside for preferred advertisers. In another example, inventory from high-demand, high-value pockets may not be offered to certain “run of” campaigns that are searching for inventory across the board. Such inventory may be referred to as “protected inventory.”

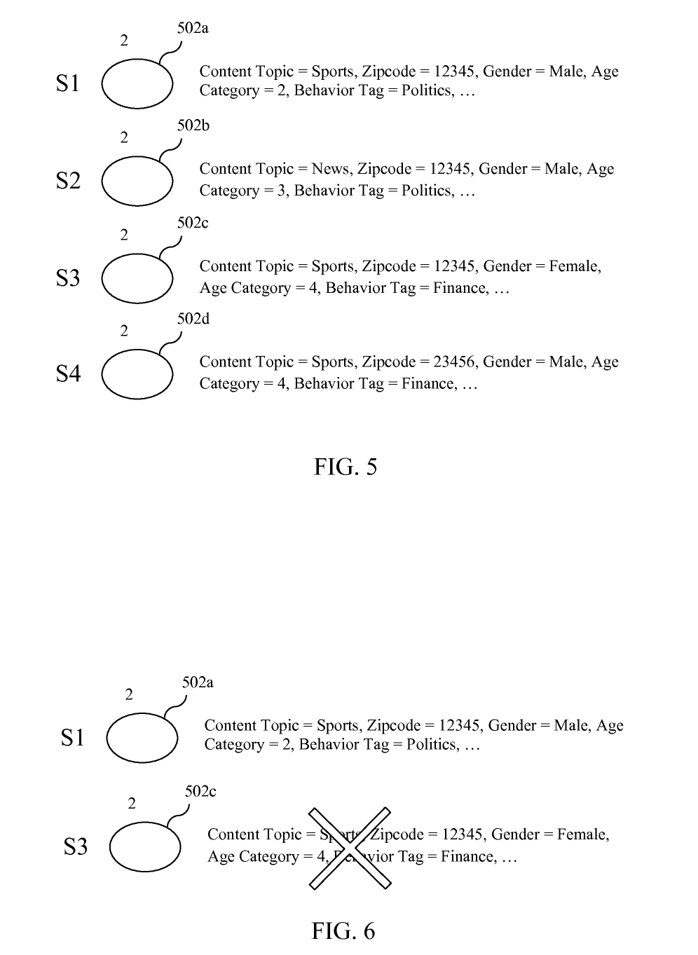

An example of processing a received query with regard to advertisement inventory that includes protected inventory is described as follows with respect to FIGS. 5 and 6. FIG. 5 illustrates four supply samples, S1-S4 (corresponding to reference numerals 502a-502d), that may be returned by supply forecasting system 144 in response to the submission of a given query. Each of supply samples S1-S4 is shown having a weight of 2 (representing 2 advertising opportunities) for purposes of illustration, but may have any other value in other situations. In the example of FIG. 5, a query seeking advertising opportunities may be received, such as query Q10 shown below:

Q10: Content Topic=Sports, Zipcode=12345

In accordance with this example, supply forecasting system 144 may determine that samples S1 and S3 match query Q10, as they each have an attribute value of “Sports” for the attribute “ContentTopic,” and have an attribute value of “12345” for the attribute “Zipcode.” As such, FIG. 6 shows samples S1 and S3 (corresponding to reference numerals 502a and 502c) that match query Q10 shown above. Note that for purposes of illustration, a duration attribute and attribute value (e.g., Duration=Mar. 15, 2011-Mar. 31, 2011) are not shown included in Q10 (or in the examples provided below), but in embodiments, such a duration may be indicated as an attribute as desired.

However, in the example of FIGS. 5 and 6, advertising inventory that includes the attribute value “Finance” for the attribute “Behavior Tag” is designated as protected inventory. This may be because a publisher (e.g., web site provider, etc.) of advertisement impressions may desire to charge a premium for viewers associated with the attribute value “Finance” for the attribute “Behavior Tag,” and/or for other reasons. Supply forecasting system 144 may determine that sample S3 is not eligible supply for query Q10, because sample S3 has the attribute value “Finance” for the attribute “Behavior Tag.” As such, supply forecasting system 144 may determine that sample S1 is alone eligible for supply for query Q10, and accordingly may determine that the total number of advertising opportunities available is 2, based on the weight of “2” associated with sample S1 (sample S3 is shown marked with an “X” as not eligible due to being designated as protected inventory).

Advertisement serving systems may enable administrators and/or business users to specify a set of inventory-qualification rules or inventory protection rules for protected inventory, with each rule indicating a subset of the inventory and the advertising campaigns that qualify for that subset. Such subsets of inventory defined by the rules may overlap because various types of rules may be defined, including generic rules and specific rules, and as well as rules having multiple considerations for being triggering for different campaigns.

Where protected inventory is present, such as in the example of FIGS. 5 and 6, the advertisement serving system determines which subsets of inventory are not accessible for an advertising campaign, and accordingly influences the computation of eligible/available inventory for that campaign. In other words, each impression that may otherwise match an advertising campaign is checked for its membership in one or more protected inventory packages, and the advertising campaign is not allowed to access those protected inventory packages.

An advertisement serving system may manage a large number of advertising campaigns (e.g., thousands, millions, etc.) and a large number of advertisement impressions (e.g., billions). Even with the sampling techniques that compactly represent relevant inventory through samples, there may still be large numbers (e.g., thousands) of impression samples to process. Therefore, even with a moderately small number of inventory-qualification rules, the computational problem is a huge challenge.

Furthermore, response times in the order of a few seconds for advertising campaign booking cannot be supported by an advertisement serving system if simplistic solutions for processing the inventory-qualification rules are used. What is needed are scalable solutions to ensure inventory protection/optimization with respect to the inventory packages while at the same time maintaining low latency for critical operations.

Embodiments enable the determination of eligible inventory to be performed in ways that take into account protected inventory. Embodiments leverage the techniques described above for determining eligible supply, thereby ensuring high performance and scalability of advertising systems. In an embodiment, a “query rewriting” technique is used to modify the associated information with each advertising campaign to factor in the inventory-qualification rules.

For instance, for an advertising campaign that specifies the required characteristics of the relevant inventory for the campaign, along with the other aspects of the campaign such as advertiser id, campaign priority, etc., the inventory-qualification rules are evaluated to determine which rules are triggered by the campaign. In an embodiment, the campaign may be tagged with the corresponding subsets of inventory that are not accessible to the campaign. Thus, an existing campaign specification is enhanced according to these restrictions.

When finding matching/relevant ad impressions for an advertising campaign, the inventory specification for the campaign, as well as the additional restrictions imposed due to the inventory protection rules are analyzed. The advertising campaign specification may be modified to probe the impression index in order to identify any matching/relevant inventory for the campaign. According to this technique, the inventory protection/optimization rules can be factored into the analysis in an efficient manner. To determine the contention/allocation across multiple advertising campaigns for a given set of advertising impressions, entries stored in an inverted index of campaign information may be modified. When an impression is used to probe/query this inverted index, the matching campaigns that are determined automatically factor in the inventory-qualification rules, because the index entries for the campaigns have the corresponding restrictions included.

In embodiments, inventory qualification rules/inventory protection rules for protecting inventory may be configured in different forms, including as attributes and attribute values, or alternatively in the form of tags. The next subsection describes the use of attributes and attribute values as inventory protection rules, followed by a subsection that describes the use of tags as inventory protection rules.

1. Example Query Processing Techniques for Handling Protected Inventory Using Inventory Protection Attributes and Attribute Values

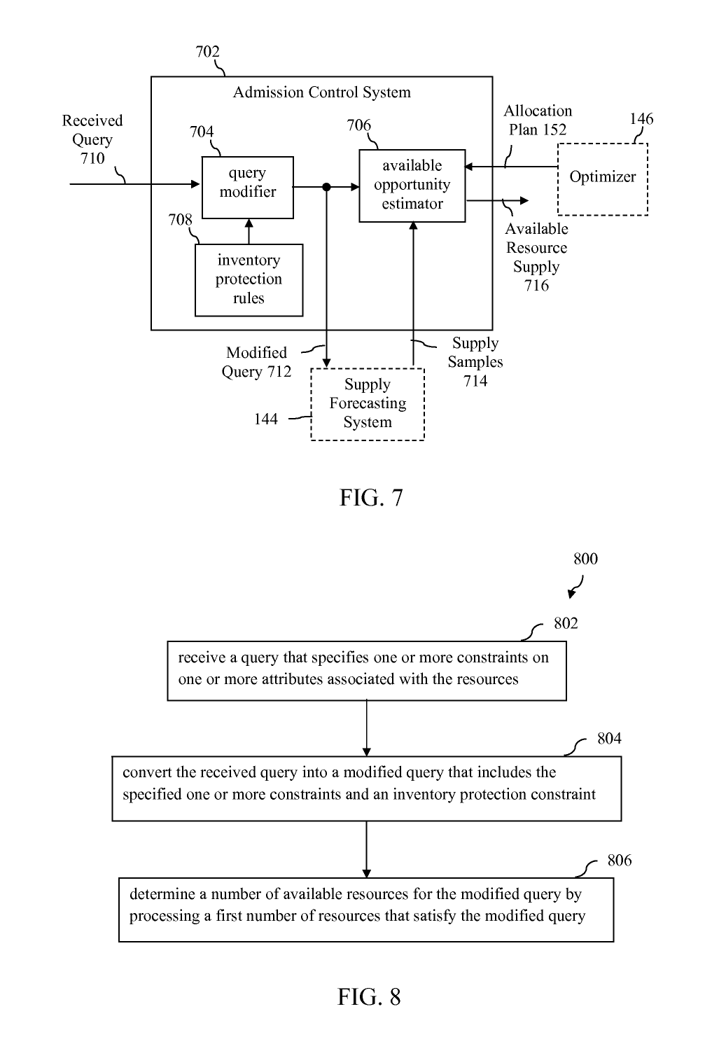

Embodiments may be incorporated into advertising serving systems, such as advertisement serving system 100 of FIG. 1. For instance, FIG. 7 shows a block diagram of an admission control system 702, according to an example embodiment. Admission control system 702 is configured to rewrite received queries so that protected inventory is avoided. In an embodiment, admission control system 702 of FIG. 7 may be implemented in system 100 of FIG. 1 in place of admission control system 142. As shown in FIG. 7, admission control system 702 includes a query modifier 704 and an available opportunity estimator 706. Admission control system (ACS) 702 is described in further detail as follows.

As shown in FIG. 7, query modifier 704 of ACS 702 receives a query 710. Received query 710 is a query for resources, such as advertising opportunities. As described above, a query specification of query 710 may provide one or more attributes and corresponding attribute values associated with the advertising opportunities. As shown in FIG. 7, query modifier 704 receives inventory protection rules 708. Inventory protection rules 708 indicate one or more protected subsets of advertisement inventor according to one or more defined inventory protection rules. For instance, each inventory protection rule may indicate one or more attributes and corresponding attribute values that correspond to a subset of protected inventory (e.g., behavior tag=“finance”, content topic=“super bowl”, etc.). Query modifier 704 may compare inventory protection rules 708 to the query specification of received query 710 to determine whether received query 710 targets protected inventory. Note that inventory protection rules 708 may include rules related to attributes such as “behavior tag”, “content topic”, “position”, “demographic information,” “geographic information,” “date range”, and/or other attributes related to inventory. Furthermore, inventory protection rules 708 may include further rules related to other aspects of received queries, such as the identity of the customer that submitted the received query. For instance, particular inventory may desired to be protected such that a particular set of customers (e.g., advertisers, etc.) may have access to the inventory, and that another set of customers may not have access to the inventory.

Query 710 may be configured to specifically target protected inventory if query 710, as configured, only targets protected inventory. In such case, it may be desired for query 710 to not be modified, and to be applied against the protected inventory as described above for queries targeted against advertisement inventory. Alternatively, query 710 may non-specifically target protected inventory if query 710, as configured, targets both protected inventory and non-protected inventory. If query modifier 704 determines that query 710 non-specifically targets protected inventory, query modifier 704 may modify query 710. For instance, query modifier 704 may modify received query 710 to generate a modified query 712. Modified query 712 is configured to target the non-protected inventory targeted by received query 710 while avoiding targeting the protected inventory targeted by received query 710. Query modifier 704 may generate modified query 712 to avoid targeting protected inventory in various ways that cause the protected inventory from being matched by modified query 712.

As shown in FIG. 7, modified query 712 is received from query modifier 704 by supply forecasting system 144. As described above, supply forecasting system 144 is configured to determine one or more supply samples that correspond to queries. In an embodiment, supply forecasting system 144 may process modified query 712 in the manner it would process an un-modified query. For instance, with respect to modified query 712, supply forecasting system 144 may generate a first number of supply samples 714. Note that first number of supply samples 714 obtained for modified query 714 may be less than a second number of supply samples that would be determined by supply forecasting system 144 for received query 710. This is because any supply samples that would be determined by supply forecasting system 144 for received query 710 that include protected inventory are not included in first number of supply samples 714.

As shown in FIG. 7, available opportunity estimator 706 receives supply samples 714 from supply forecasting system 144. Furthermore, available opportunity estimator 706 receives allocation plan 152 (from optimizer 146 of FIG. 1). As described above, allocation plan 152 indicates which advertising opportunities have been booked by which advertising campaigns. Available opportunity estimator 706 is configured to use the most recently-received allocation plan 152 to make decisions about booking new advertising campaigns, as described above. For example, available opportunity estimator 706 may process allocation plan 152 along with forecasted supply information in supply samples 714 received from supply forecasting system 144 to determine a number of advertising opportunities available to be booked by a new advertising campaign corresponding to received query 710. As shown in FIG. 7, available opportunity estimator 706 may generate available resource supply 716, which indicates the number of advertising opportunities that are available corresponding to received query 710, while avoiding counting advertising opportunities associated with protected inventory. Available resources supply 716 may be received by the user submitting received query 710 (e.g., may be displayed in a user interface). Furthermore, if an advertisement campaign is booked based on available resource supply 716, available resource supply 716 may be provided to campaign log 150 (FIG. 1) so that such information may be subsequently considered by optimizer 146 when generating an updated version of allocation plan 152.

FIG. 8 shows a flowchart 800 providing a process for processing a query for available resources by modifying the query to avoid protected inventory, according to an example embodiment. In an embodiment, flowchart 800 may be performed by admission control system 702 of FIG. 7. Further structural and operational embodiments will be apparent to persons skilled in the relevant art(s) based on the discussion regarding flowchart 800. Flowchart 800 is described as follows.

Flowchart 800 begins with step 802. In step 802, a query is received that specifies one or more constraints on one or more attributes associated with the resources. For example, as shown in FIG. 7, query 710 is received at ACS 702 by query modifier 704. Received query 710 specifies one or more constraints on one or more attributes associated with resources. Such constraints may have various forms. For instance, in an embodiment, a constraint may have the form of an attribute and one or more target values for the attribute. When the constraints have the form of attributes and corresponding target values, received query 710 can have any number of attributes, and each attribute can have any number of target values. Note that for illustrative purposes, query constraints are frequently described herein in terms of attributes and corresponding target values. However, this example is not intended to be limiting, and in alternative embodiments, query constraints may have alternative forms.

For instance, received query 710 may be query Q10 shown above, having the attribute-attribute value pairs of Content Topic=Sports, Zipcode=12345.

In step 804, the received query is converted into a modified query that includes the specified one or more constraints and an inventory protection constraint. For instance, query modifier 704 may compare received query 710 to inventory protection rules 708, which define protected inventory. If query modifier 704 determines that the attributes and corresponding attribute values of received query 710 match or overlap with any of inventory protection rules 708 (e.g., “content type”, “customer identifier”, etc.), query modifier 704 may convert received query 710 to modified query 712, which is configured to avoid matching the protected inventory defined by inventory protection rules 708.

For instance, inventory protection rules 708 may include an inventory protection rule R1 shown below:

R1: Content Topic=Super Bowl

According to inventory protection rule R1, inventory having the attribute of “content topic” with attribute value of “super bowl” is designated as protected inventory. Such protected inventory may not be targeted by a received query (e.g., unless the received query targets the protected query specifically with the identical attribute(s) and attribute value(s)). With reference to received query 710 being query Q10 shown above, query modifier 704 may determine that query Q10 matches the protected inventory defined by inventory protection rule R1, because the attribute of “content topics” having the attribute value of “sports” of query Q10 overlaps with the attribute of “content topics” having the attribute value of “super bowl” of R1 (“super bowl” is a subset of “sports”). As such, query Q10 targets protected inventory covered by inventory protection rule R1, and therefore is to be modified by query modifier 704.

Query modifier 704 may modify received query 710 in various ways to avoid covering protected inventory. For instance, in an embodiment, query modifier 704 may incorporate the particular inventory protection rule that is matched or overlapped into received query 710 as an inventory protection constraint to generate modified query 712.

For instance, continuing the example from above, query modifier 704 may modify query Q10 by incorporating inventory protection rule R1 into query Q10 in a “NOT” statement, or in other manner, to exclude the scope of inventory protection rule R1 from query Q10. An example of such a modification to query Q10 is shown below as modified query MQ10:
MQ10: Content Topic=Sports, Zipcode=12345, NOT (Content Topic=Super Bowl)
   As such, in an embodiment, query modifier 704 may generate MQ10 as modified query 712 based on query Q10 being received query 710. In further embodiments, modified query MQ10 may be generated by query modifier 704 to have other forms.

Note that in the above example, inventory protection rule R1 has a single attribute-attribute value pair. In further examples, inventory protection rules may have multiple attribute-attribute value pairs. For instance, an example inventory protection rule R2 shown below has three attribute-attribute value pairs:

R2: Content Topic=Super Bowl, Zipcode=23456, Position=NREC

Referring back to flowchart 800 in FIG. 8, in step 806, a number of available resources is estimated for the modified query by processing a first number of resources obtained for the modified query. For instance, referring to FIG. 7, supply forecasting system 144 may receive modified query 712, and may generate supply samples 714 based on modified query 712 in a manner as described further above, or otherwise known. Available opportunity estimator 706 may receive modified query 712, supply samples 714, and allocation plan 152, and may generate available resource supply 716. Note that in alternative embodiments, available opportunity estimator 706 may determine available resource supply 716 based on individual advertising opportunities rather than supply samples, or in other ways.

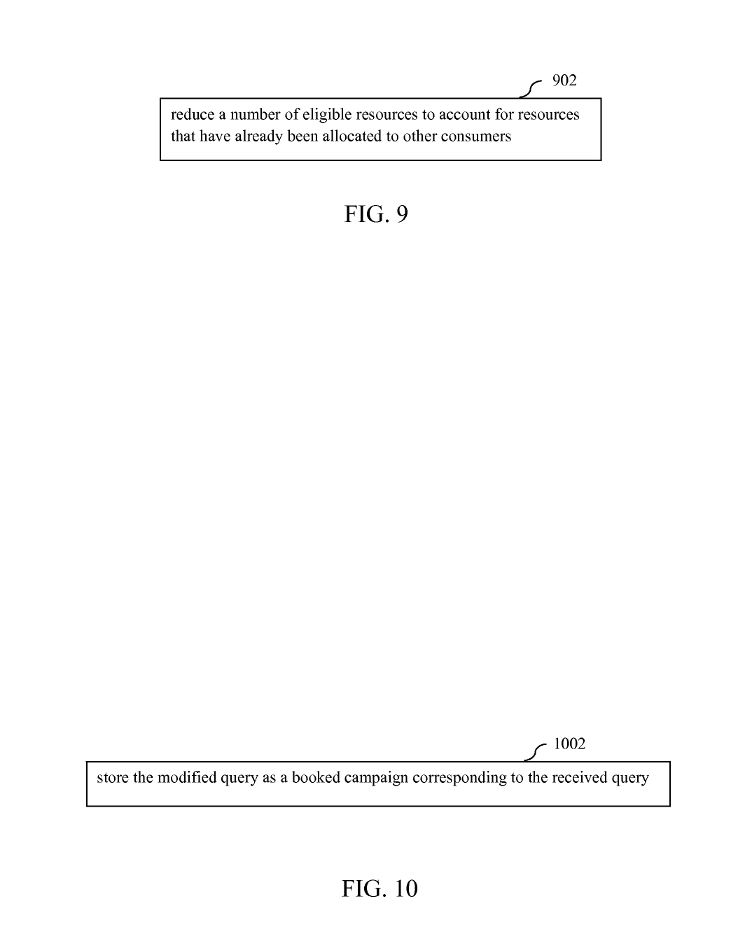

For instance, FIG. 9 shows a step 902 providing a process for performing step 806 of flowchart 800. In step 902, a number of eligible resources is reduced to account for resources that have already been allocated to other consumers. For instance, step 902 may be performed by available opportunity estimator 706 of FIG. 7 in a manner as described above. For example, available opportunity estimator 706 may use allocation plan 152 obtained from optimizer 146 to determine how much of the forecasted supply represented by supply samples 714 (or individual opportunities) is already allocated to existing advertising campaigns and reduces the forecasted supply accordingly to identify an available supply (e.g., as described with respect to FIG. 4 for admission control system 142 of FIG. 1).

If an advertisement campaign associated with received query 710 is booked, admission control system 702 may transmit the information regarding the booking to campaign log 150 to be stored as an advertising campaign. As an ongoing matter, Optimizer 146 operates to obtain a forecasted supply of advertising opportunities from supply forecasting system 144 and allocates such forecasted supply among various existing advertising campaigns, based on the information stored in campaign log 150. In particular, optimizer 146 uses information about future supply obtained from supply forecasting system 144 and booked demand obtained from campaign log 150 to update allocation plan 152.

An advertising campaign based on a query may be stored in campaign log 150 to include information similar to that shown for advertising campaigns C2-C5 shown in FIG. 3. In embodiments, where a modified query is generated, the advertising campaign may be stored with or without the added information corresponding to the protected inventory. For instance, FIG. 10 shows a step 1002 providing a process for storing a booked advertising campaign based on a modified query, according to an example embodiment. In step 1002, the modified query is stored as a booked campaign corresponding to the received query. The advertising campaign may be stored with the constraints (e.g., one or more attributes and attribute values) received in received query 710, the inventory protection constraints (e.g., one or more added attributes and attribute values corresponding to the protected inventory), and a number of advertisement opportunities determined/desired to be consumed by the advertising campaign.

In the manner of FIG. 10 where modified query 712 is stored as a booked campaign, and when advertisement demand by existing advertising campaigns is determined in the future (e.g., as described above with respect to FIG. 4), the coverage by the advertising campaign will reflect the reduced scope due to the additional constraints imposed by the included inventory protection rules.

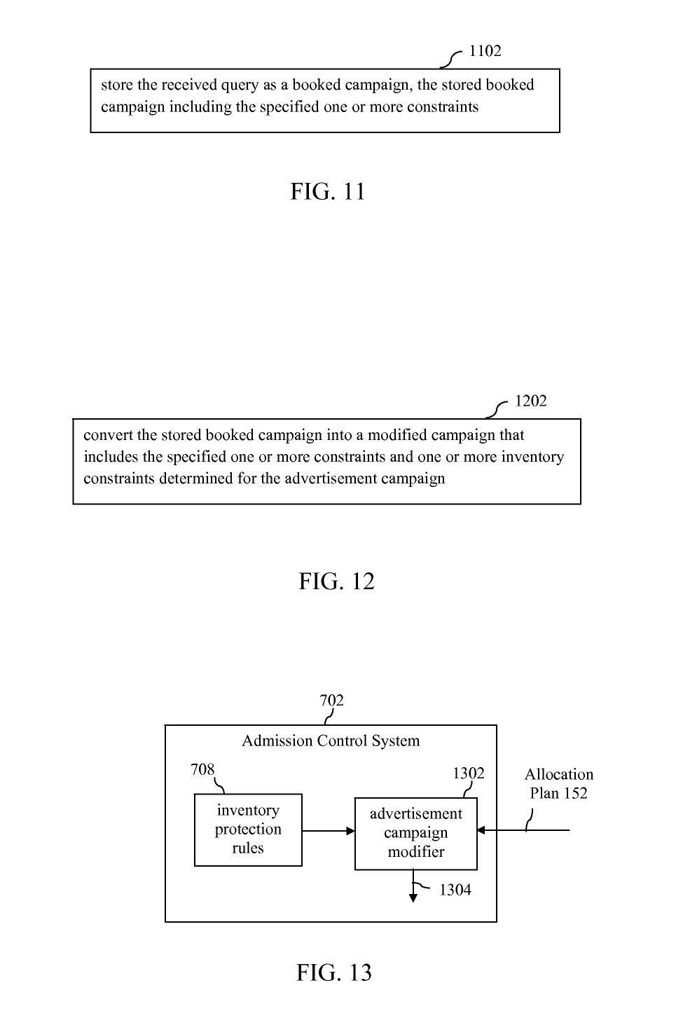

Alternatively, FIG. 11 shows a step 1102 providing a process for storing a booked advertising campaign based on the originally received query, according to an example embodiment. In step 1102, the received query is stored as a booked campaign, the stored booked campaign including the specified one or more constraints. For example, the advertising campaign may be stored with the one or more attributes and attribute values received in received query 710, and a number of advertisement opportunities determined/desired to be consumed by the advertising campaign. However, the inventory protection attributes and attribute values added to modified query 712 are not stored in the booked advertising campaign.

As such, in the manner of FIG. 11 where received query 710 is stored as a booked campaign, and when advertisement demand by existing advertising campaigns is determined in the future, any existing inventory protection rules that are applicable to the advertisement campaigns may be processed at that time. These inventory protection rules may include those used to generate modified query 712 and/or inventory protection rules received subsequent to that time. For instance, FIG. 12 shows a step 1202 providing a process for converting campaigns into modified campaigns, according to an example embodiment. In step 1202, the stored booked campaign is converted into a modified campaign that includes the specified one or more constraints and one or more inventory protection constraints (e.g., inventory protection attributes and corresponding inventory protection attribute values) determined for the campaign. Step 1202 may be performed at any time, including when a subsequent query is received and available inventory for the subsequent query is to be determined.

For example, FIG. 13 shows a block diagram of admission control system 702, according to an embodiment. As shown in FIG. 13, admission control system 702 may include an advertisement campaign modifier 1302. Advertisement campaign modifier 1302 may be configured to perform step 1202 of FIG. 12. For instance, advertisement campaign modifier 1302 may receive inventory protection rules 708 and allocation plan 152. When a query is received by admission control system 702 (e.g., received query 710 in FIG. 7), for each advertisement campaign in allocation plan 152, advertisement campaign modifier 1302 may compare inventory protection rules 708 to the advertisement campaign(s) to determine whether they target any protected inventory. If advertisement campaign modifier 1302 determines that the attributes and corresponding attribute values of an advertisement campaign match or overlap with any of inventory protection rules 708, advertisement campaign modifier 1302 may convert the advertisement campaign to a modified advertisement campaign, which is configured to avoid matching the protected inventory defined by inventory protection rules 708. Advertisement campaign modifier 1302 may modify an advertisement campaign in various ways to avoid covering protected inventory. For instance, in an embodiment, advertisement campaign modifier 1302 may incorporate the one or more particular inventory protection rules that are matched or overlapped into the advertisement campaign.

As shown in FIG. 7, advertisement campaign modifier 1302 generates modified advertisement campaigns 1304, which includes any modified advertisement campaigns. Available opportunity estimator 706 of FIG. 7 may receive modified advertisement campaigns 1304, and may determine available inventory for a received query as described above, using any modified advertisement campaigns provided in modified advertisement campaigns 1304 in place of the un-modified versions.

2. Example Query Processing Techniques for Handling Protected Inventory Using Inventory Protection Tags

As described above, inventory protection tags may be used to avoid targeting of protected inventory by queries. For instance, referring to FIG. 7, inventory protection rules 708 may define inventory protection tags. An inventory protection tag includes a tag identifier (e.g., T1, T2, etc.) and a corresponding tag definition (e.g., content topic=super bowl, position=NREC, etc.). Inventory protection tags may be used in inventory queries and in the advertisement campaign specifications. As such, instead of specifying constraints to prevent protected inventory from matching a query as described in the prior subsection, a list of tags may be provided as a compact representation for protected inventory subsets. Furthermore, tags can provide a compact representation of protection constraints for advertisement campaign specifications.

Still further, tags may be used to annotate specific inventory items. For instance, for each inventory item, a list of protected sets of inventory that the inventory item belongs to may be determined, and the inventory item may be tagged with the tag identifiers for the determined sets of inventory. Such tagging of inventory items can be done offline as a part of the generating of opportunity samples in the supply forecasting system (e.g., supply forecasting system 144 of FIG. 1). The tagged inventory items may be indicated/stored in ad log 148, to be accessed by supply forecasting system of FIG. 1 to be used to forecast available supply and generate supply samples.

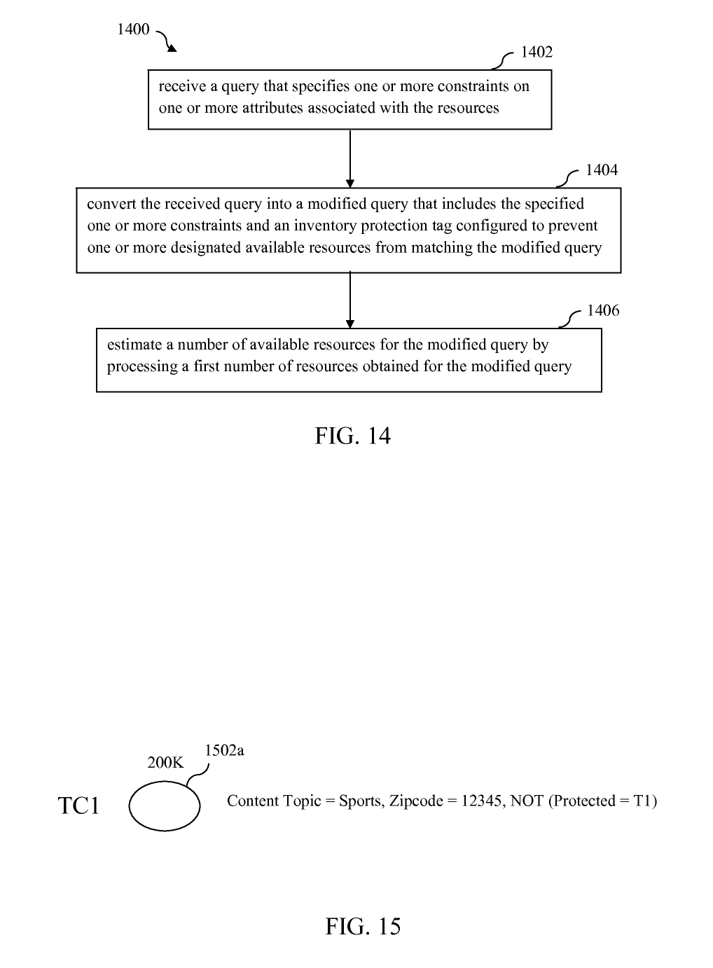

Tags may be used to protect inventory in various ways. For instance, FIG. 14 shows a flowchart 1400 providing a process for processing a query for available resources by modifying the query to avoid protected inventory using tags, according to an example embodiment. In an embodiment, flowchart 1400 may be performed by admission control system 702 of FIG. 7. Further structural and operational embodiments will be apparent to persons skilled in the relevant art(s) based on the discussion regarding flowchart 1400. Flowchart 1400 is described as follows.

Flowchart 1400 begins with step 1402. In step 1402, a query is received that specifies one or more constraints on one or more attributes associated with the resources. For example, as shown in FIG. 7, query 710 is received at ACS 702 by query modifier 704. As described above, received query 710 specifies one or more constraints, such as constraints in the form of attributes and one or more target values for each of the attributes. Received query 710 can have any number of constraints, including any number of attributes that each have any number of target values.

For instance, received query 710 may be query Q10 shown above, having the attribute-attribute value pairs of Content Topic=Sports and Zipcode=12345.

In step 1404, the received query is converted into a modified query that includes the specified one or more constraints and an inventory protection tag configured to prevent one or more designated available resources from matching the modified query. For instance, query modifier 704 may compare received query 710 to inventory protection rules 708, which define attributes and attribute values of protected inventory. If query modifier 704 determines that the constraints (e.g., attributes and corresponding attribute values) of received query 710 match or overlap with inventory protection rules 708, query modifier 704 may convert received query 710 to modified query 712, which is configured to avoid matching the protected inventory defined by inventory protection rules 708.

For instance, inventory protection rules 708 may include an inventory protection rule represented by tag T1 shown below:

T1: Content Topic=Super Bowl

According to tag T1, inventory having the attribute of “content topic” with attribute value of “super bowl” is designated as protected inventory. Such protected inventory is prevented from being targeted by a received query (e.g., unless the received query targets the protected query specifically with the identical attribute(s) and attribute value(s)). With reference to received query 710 being query Q10 shown above, query modifier 704 may determine that query Q10 matches the protected inventory defined by tag T1, because the attribute of “content topics” having the attribute value of “sports” of query Q10 overlaps with the attribute of “content topics” having the attribute value of “super bowl” of tag T1 (“super bowl” is a subset of “sports”). As such, query Q10 targets protected inventory covered by tag T1, and therefore query Q10 designated for modification by query modifier 704.

Inventory protection rules 708 may include a list of tags, such as tag T1, and the inventory protection attributes and corresponding attribute values that correspond to each tag. In this manner, query modifier 704 can determine which tag to assign to a query based on the inventory protection attributes and attribute values that match the query.

In an embodiment, query modifier 704 may incorporate the particular tag that is matched or overlapped by received query 710 into received query 710 to generate modified query 712. For instance, continuing the example from above, query modifier 704 may modify query Q10 by incorporating the identifier for tag T1 into query Q10. An example of such a modification to query Q10 is shown below as tagged query TQ10:

TQ10: Content Topic=Sports, Zipcode=12345, NOT (Protected=T1)

In this example, the query Q10 is tagged with the “NOT” condition followed by “(Protected=T1)”, where the tag identifier is inserted at “T1”, to form TQ10. Accordingly, query Q10 avoids the protected inventory associated with tag T1 (Content Topic=Super Bowl). This is different from the embodiment described further above where an attribute and attribute value (e.g., “content topic=super bowl”) is explicitly added to query Q10 to form modified query MQ10. By tagging query Q10, a more compact modified query may be generated.

As such, in an embodiment, query modifier 704 may generate TQ10 as modified query 712 based on query Q10 being received query 710. In further embodiments, modified query TQ10 may be tagged by query modifier 704 in other ways.

Note that in the above example, a single tag is added to query Q10 to form modified query TQ10. In further examples, multiple tags may be added to a received query. An example of query Q10 modified with multiple tags is shown below as tagged query TQ10:

TQ10: Content Topic=Sports, Zipcode=12345, NOT (Protected=T1, T3)

In this example, the query Q10 is tagged with a first tag T1 and a third tag T3 to form modified query TQ10.

In step 1406, a number of available resources is estimated for the modified query by processing a first number of resources obtained for the modified query. For instance, referring to FIG. 7, supply forecasting system 144 may receive modified query 712 (having been tagged with one or more tags), and may generate supply samples 714 based on modified query 712 in a manner as described further above (e.g., with respect to FIGS. 1 and 2, and/or with respect to step 806 of FIG. 8), or otherwise known. Available opportunity estimator 706 may receive modified query 712, supply samples 714 (or individual opportunities), and allocation plan 152, and may determine available resource supply 716. For example, available opportunity estimator 706 may determine available resource supply 716 in a similar manner as described above with respect to step 902 of FIG. 9.

As described above, if an advertisement campaign associated with received query 710 is booked, admission control system 702 may transmit the information regarding the booking to campaign log 150 to be stored as an advertising campaign.

An advertising campaign based on a query modified with tags may be stored in campaign log 150 to include information similar to that shown for advertising campaigns C2-C5 shown in FIG. 3. The advertising campaign may be stored with or without information corresponding to the protected inventory. For instance, referring to FIG. 10 described above, the modified query may be stored as a booked campaign corresponding to the received query, including storing the advertising campaign with the one or more attributes and attribute values received in received query 710, the one or more added inventory protection tags, and a number of advertisement opportunities desired to be consumed by the advertising campaign (e.g., which may be submitted by a user at a user interface).

For instance, FIG. 15 illustrates a tagged advertising campaign 1502a, according to an example embodiment. Tagged advertisement campaign 1502a, shown as tagged advertisement campaign TC1 in FIG. 15, is based on tagged query TQ10, and may be stored in campaign log 150 when booked. As shown in FIG. 15, campaign TC1 is projected to consume 200,000 advertising opportunities that have a profile of:

Content Topic=Sports, Zipcode=12345, NOT (Protected=T1).

where tag T1 causes advertising opportunities that have the attribute “Content Topic” with attribute value of “Super Bowl” to be avoided by the modified advertising campaign as protected inventory. As such, the modified advertising campaign will reflect the reduced scope due to the additional constraints imposed by the inventory protection tag.

Alternatively, as described above with respect to FIG. 11, a booked advertising campaign may be stored in campaign log 150 based on the originally received query, without including any of the tags that were added to the corresponding modified query. As such, when received query 710 is stored as a booked campaign, and when advertisement demand by existing advertising campaigns is determined in the future, any existing inventory protection rules that are applicable to the advertisement campaigns may be processed at that time, including any new inventory protection rules or other modifications to the inventory protection rules that occurred in the meantime. In a similar manner to step 1202 of FIG. 12 described above, the advertisement campaign may be converted into a modified advertisement campaign that includes the one or more attributes and corresponding target values specified in received query 710, and may include one or more inventory protection tags determined for the advertisement campaign.

For example, in an embodiment, admission control system 702 shown in FIG. 13 may convert an advertisement campaign into a modified advertisement campaign in a similar manner as described above. For instance, advertisement campaign modifier 1302 may receive allocation plan 152 and inventory protection rules 708, which includes a list of inventory protection tags. When a query is received by admission control system 702 (e.g., received query 710 in FIG. 7), for each advertisement campaign in allocation plan 152, advertisement campaign modifier 1302 may compare inventory protection rules 708 to the advertisement campaign(s) to determine whether they target any protected inventory. If advertisement campaign modifier 1302 determines that the attributes and corresponding attribute values of an advertisement campaign match or overlap with any of the tags of inventory protection rules 708, advertisement campaign modifier 1302 may convert the advertisement campaign to a modified advertisement campaign, which is configured to avoid matching the protected inventory defined by inventory protection rules 708. Advertisement campaign modifier 1302 may modify an advertisement campaign in various ways to avoid covering protected inventory. For instance, in an embodiment, advertisement campaign modifier 1302 may incorporate the one or more particular inventory protection tags that are matched or overlapped into the advertisement campaign.

As shown in FIG. 7, advertisement campaign modifier 1302 generates modified advertisement campaigns 1304, which includes any modified advertisement campaigns. Available opportunity estimator 706 of FIG. 7 may receive modified advertisement campaigns 1304, and may determine available inventory for a received query as described above, using modified advertisement campaigns 1304 in place of the un-modified versions.

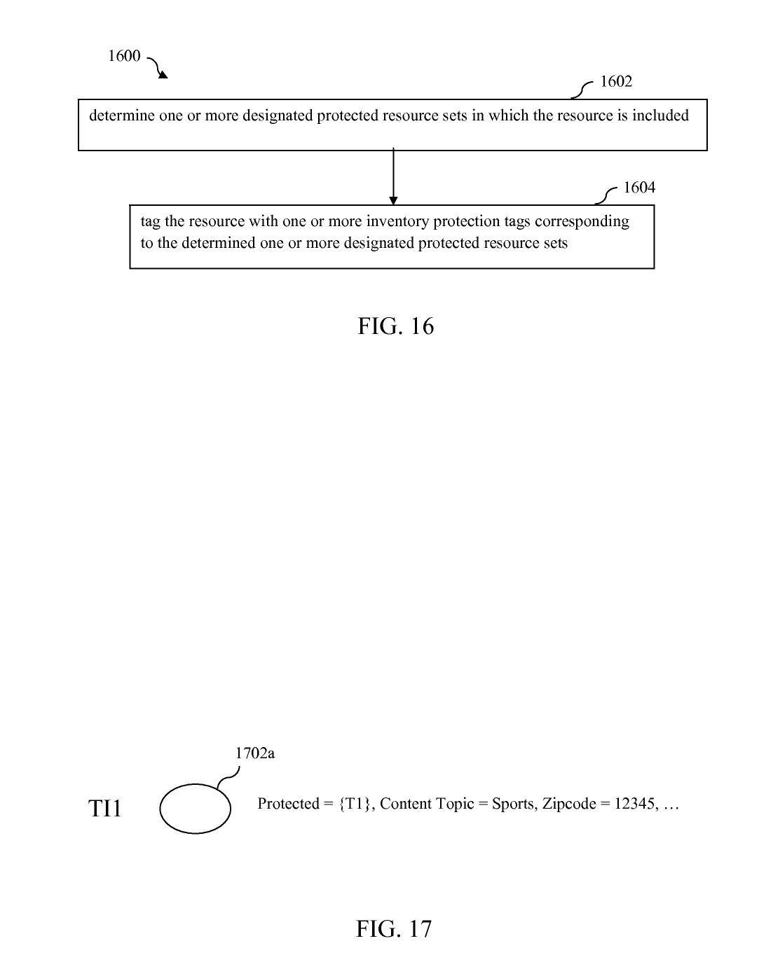

Furthermore, as described above, inventory items in a resource inventory may be tagged to indicate the sets of protected inventory in which the inventory items belong. For instance, FIG. 16 shows a flowchart 1600 for processing a resource inventory that includes a plurality of resources, according to an example embodiment. For example, flowchart 1600 may be performed by optimizer 146 or advertisement serving system 120 in FIG. 1. Flowchart 1600 may be performed on each resource, such as an advertisement or advertisement opportunity, which is stored in the resource inventory. For instance, the resource inventory may be a database or other data structure for containing resources. Flowchart 1600 is described as follows.

Flowchart 1600 begins with step 1602. In step 1602, one or more designated protected resource sets in which the resource is included are determined. For example, optimizer 146 or advertisement serving system 120 may receive information regarding a first resource. For instance, the information may include the attributes and corresponding attribute values associated with the resource. Optimizer 146 or advertisement serving system 120 may compare the attributes and corresponding attribute values to the attributes and corresponding attribute values for one or more sets of protected inventory. Such attributes and corresponding attribute values for the sets of protected inventory may be determined from the attributes and corresponding attribute values included in inventory protection rules 708 (FIG. 7) for the listed tags.

In step 1604, the resource is tagged with one or more inventory protection tags corresponding to the determined one or more designated protected resource sets. For example, optimizer 146 or advertisement serving system 120 may tag the resource with the one or more inventory protection tags corresponding to any protected resource set in which the resource is determined to be included.

For instance, FIG. 17 illustrates a tagged inventory item 1702a, according to an example embodiment. Tagged inventory item 1702a is indicated as tagged inventory item TI1 in FIG. 17. In step 1602 of flowchart 1600, the inventory item was determined to be included in a protected resource set defined by tag T1. As such, in step 1604, the inventory item is tagged with tag T1. In the example of FIG. 17, tagged inventory item TI1 is tagged with tag T1 by adding the text “Protected={T1}”, with the tag identifier for tag T1 entered as “T1” within the brackets. Further tag identifiers may be added within the brackets to indicate further protected resource sets in which the inventory item is included.

As such, when a resource impression request is received, the impression request may be tagged, and the tagged impression request may be compared against the tagged resource inventory to prevent the impression request from covering protected inventory.

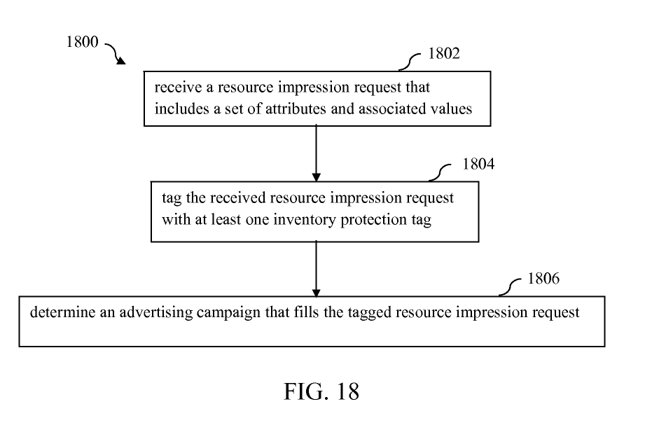

For instance, FIG. 18 shows a flowchart 1800 providing a process for processing a received impression request, according to an example embodiment. In an embodiment, flowchart 1800 may be performed by advertisement serving system 120 of FIG. 1. Further structural and operational embodiments will be apparent to persons skilled in the relevant art(s) based on the discussion regarding flowchart 1800. Flowchart 1800 is described as follows.

Flowchart 1800 begins with step 1802. In step 1802, a resource impression request is received that includes a set of attributes and associated values. For example, as shown in FIG. 18, advertisement serving system 120 may receive an impression request 160. Impression request 160 includes a set of attributes and associated attribute values that define the characteristics of an advertisement to be served in response to impression request 160, as described above.

In step 1804, the received resource impression request is tagged with at least one inventory protection tag. In an embodiment, impression request 160 may be tagged with at least one inventory protection tag that defines protected inventory that impression request 160 overlaps.

In step 1806, an advertisement campaign is determined that fills the tagged resource impression request. For instance, advertisement serving system 120 may match the tagged impression request with one or more maintained advertisement campaigns, which themselves may be tagged. Subsequently, an advertisement may be served from a matching advertisement campaign in response to resource impression request 160.

### E. Example Computer System Implementation

Inventory management system 110, advertisement serving system 120, admission control system 142, supply forecasting system 144, optimizer 146, query modifier 704, available opportunity estimator 706, advertisement campaign modifier 1302, and/or any further systems, sub-systems, and/or components disclosed herein may be implemented in hardware, software, firmware, or any combination thereof. For example, inventory management system 110, advertisement serving system 120, admission control system 142, supply forecasting system 144, optimizer 146, query modifier 704, available opportunity estimator 706, and/or advertisement campaign modifier 1302 may be implemented as computer program code configured to be executed in one or more processors. Alternatively, inventory management system 110, advertisement serving system 120, admission control system 142, supply forecasting system 144, optimizer 146, query modifier 704, available opportunity estimator 706, and/or advertisement campaign modifier 1302 may be implemented as hardware logic/electrical circuitry.

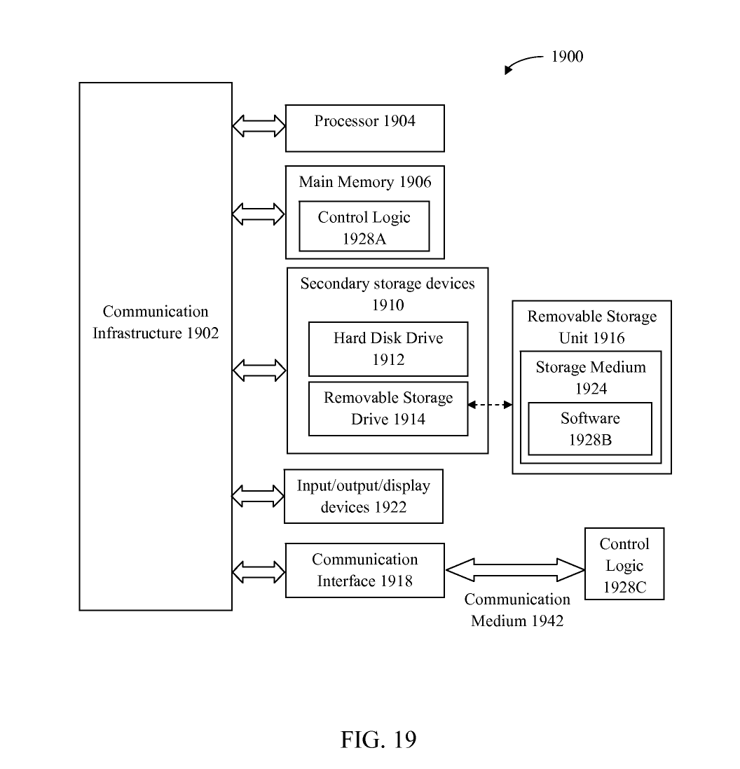

The embodiments described herein, including systems, methods/processes, and/or apparatuses, may be implemented using well known servers/computers, such as a computer 1900 shown in FIG. 19. For example, inventory management system 110, advertisement serving system 120, and any of the sub-systems or components contained therein may be implemented using one or more computers 1900.

Computer 1900 can be any commercially available and well known computer capable of performing the functions described herein, such as computers available from International Business Machines, Apple, Sun, HP, Dell, Cray, etc. Computer 1900 may be any type of computer, including a desktop computer, a server, etc.

Computer 1900 includes one or more processors (also called central processing units, or CPUs), such as a processor 1904. Processor 1904 is connected to a communication infrastructure 1902, such as a communication bus. In some embodiments, processor 1904 can simultaneously operate multiple computing threads.

Computer 1900 also includes a primary or main memory 1906, such as random access memory (RAM). Main memory 1906 has stored therein control logic 1928A (computer software), and data.

Computer 1900 also includes one or more secondary storage devices 1910. Secondary storage devices 1910 include, for example, a hard disk drive 1912 and/or a removable storage device or drive 1914, as well as other types of storage devices, such as memory cards and memory sticks. For instance, computer 1900 may include an industry standard interface, such a universal serial bus (USB) interface for interfacing with devices such as a memory stick. Removable storage drive 1914 represents a floppy disk drive, a magnetic tape drive, a compact disk drive, an optical storage device, tape backup, etc.

Removable storage drive 1914 interacts with a removable storage unit 1916. Removable storage unit 1916 includes a computer useable or readable storage medium 1924 having stored therein computer software 1928B (control logic) and/or data. Removable storage unit 1916 represents a floppy disk, magnetic tape, compact disk, DVD, optical storage disk, or any other computer data storage device. Removable storage drive 1914 reads from and/or writes to removable storage unit 1916 in a well known manner.

Computer 1900 also includes input/output/display devices 1922, such as monitors, keyboards, pointing devices, etc.

Computer 1900 further includes a communication or network interface 1918. Communication interface 1918 enables computer 1900 to communicate with remote devices. For example, communication interface 1918 allows computer 1900 to communicate over communication networks or mediums 1942 (representing a form of a computer useable or readable medium), such as LANs, WANs, the Internet, etc. Network interface 1918 may interface with remote sites or networks via wired or wireless connections.

Control logic 1928C may be transmitted to and from computer 1900 via the communication medium 1942.

Any apparatus or manufacture comprising a computer useable or readable medium having control logic (software) stored therein is referred to herein as a computer program product or program storage device. This includes, but is not limited to, computer 1900, main memory 1906, secondary storage devices 1910, and removable storage unit 1916. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing the features of inventory management system 110, advertisement serving system 120, admission control system 142, supply forecasting system 144, optimizer 146, query modifier 704, available opportunity estimator 706, advertisement campaign modifier 1302, flowchart 800, step 902, step 1002, step 1102, step 1202, flowchart 1400, flowchart 1600, flowchart 1800 (including any step of flowcharts 800, 1400, 1600, and 1800), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### F. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for determining the eligibility of resources, comprising:
receiving a query that specifies one or more constraints on one or more attributes associated with the resources;
converting the received query into a modified query that includes the specified one or more constraints and an inventory protection constraint, the inventory protection constraint configured to prevent one or more designated eligible resources from matching the modified query; and
determining a number of eligible resources for the modified query by processing a first number of resources that satisfy the modified query;
wherein the first number of resources determined to satisfy the modified query is less than a second number of resources associated with the received query.

2. The method of claim 1, wherein the resources comprise advertisement opportunities.

3. The method of claim 1, wherein said converting the received query into a modified query that includes the specified one or more constraints and an inventory protection constraint comprises:
including a plurality of inventory protection constraints in the modified query that are each configured to prevent one or more corresponding designated eligible resources from matching the modified query.

4. The method of claim 1, wherein said converting the received query into a modified query that includes the specified one or more constraints and an inventory protection constraint comprises:
selecting the inventory protection constraint based on at least one of a query specification of the received query or a customer that submitted the received query.

5. The method of claim 1, wherein said processing a first number of resources that satisfy the modified query comprises:
determining a set of resources that match the received query, the determined set of resources being equal to the second number of resources associated with the received query; and
removing at least one resource from the determined set of resources based on the inventory protection constraint to form the first number of resources obtained for the modified query.

6. The method of claim 5, wherein said processing a first number of resources that satisfy the modified query further comprises:
reducing a number of eligible resources to account for resources that have already been allocated to other consumers.

7. The method of claim 1, further comprising:
storing the modified query as a booked campaign corresponding to the received query, the stored booked campaign including the specified one or more constraints and the inventory protection constraint.

8. The method of claim 1, further comprising:
storing the received query as a booked campaign, the stored booked campaign including the specified one or more constraints, the stored booked campaign not including the inventory protection constraint.

9. The method of claim 8, further comprising:
converting the stored booked campaign into a modified campaign that includes the specified constraints and one or more inventory protection constraints determined for the stored booked campaign.

10. A method for determining the eligibility of resources, comprising:
receiving a query that specifies one or more constraints on one or more attributes associated with the resources;
converting the received query into a modified query that includes the specified one or more constraints and an inventory protection tag configured to prevent one or more designated eligible resources from matching the modified query; and
determining a number of eligible resources for the modified query by processing a first number of resources that satisfy the modified query;
wherein the first number of resources obtained for the modified query is less than a second number of resources associated with the received query.

11. The method of claim 10, wherein the resources comprise advertisement opportunities.

12. The method of claim 10, wherein said converting the received query into a modified query that includes the specified one or more constraints and an inventory protection tag comprises:
including a plurality of inventory protection tags in the modified query that are each configured to prevent one or more corresponding designated eligible resources from matching the modified query.

13. The method of claim 10, wherein said converting the received query into a modified query that includes the specified one or more constraints and an inventory protection tag comprises:
selecting the inventory protection tag based on at least one of a query specification of the received query or a customer that submitted the received query.

14. The method of claim 10, wherein said processing a first number of resources that satisfy the modified query comprises:
determining a set of resources that match the received query, the determined set of resources being equal to the second number of resources associated with the received query; and
removing at least one resource from the determined set of resources based on the inventory protection tag to form the first number of resources obtained for the modified query.

15. The method of claim 14, wherein said processing a first number of resources that satisfy the modified query further comprises:
reducing a number of resources represented to account for resources that have already been allocated to other consumers.

16. The method of claim 10, further comprising:
storing the modified query as a booked campaign corresponding to the received query, the stored booked campaign including the specified one or more constraints and the inventory protection tag.

17. The method of claim 10, further comprising:
storing the received query as a booked campaign, the stored booked campaign including the specified one or more constraints, the stored booked campaign not including the inventory protection tag.

18. The method of claim 17, further comprising:
converting the stored booked campaign into a modified stored booked campaign that includes the specified one or more constraints and one or more inventory protection tags determined for the stored booked campaign.

19. The method of claim 10, further comprising:
processing a resource inventory that includes a plurality of resources, said processing the resource inventory including for each resource
determining one or more designated protected resource sets in which the resource is included, and
tagging the resource with one or more inventory protection tags corresponding to the determined one or more designated protected resource sets.

20. The method of claim 19, further comprising:
receiving a resource impression request that includes a set of constraints;
tagging the received resource impression request with at least one inventory protection tag; and
determining an advertising campaign that fills the tagged resource impression request.
